(19) United States
(12) Patent Application Publication
(10) Pub. No.: US 2025/0242634 A1
(43) Pub. Date: Jul. 31, 2025

(54) TYRE TREAD

(71) Applicant: BRIDGESTONE EUROPE NV/SA, Zaventem (BE)

(72) Inventors: Alexander Kurakin, Roma (IT); Fabio Santangeli, Roma (IT); Alessandro Amenta, Roma (IT)

(21) Appl. No.: 18/853,333

(22) PCT Filed: Apr. 4, 2023
(86) PCT No.: PCT/EP2023/058897

§ 371 Date: Oct. 1, 2024

(30) Foreign Application Priority Data
Apr. 4, 2022 (EP) 22166473.3

(51) Int. Cl. B60C 1/00; B60C 11/00; C08K 3/04; C08K 3/06; C08K 3/36; C08K 5/01; C08K 5/101; C08K 5/31; C08K 5/47; C08K 5/548; C08L 7/00

(52) U.S. Cl. CPC B60C 1/0016; B60C 11/00; B60C 11/0327; C08K 3/04; C08K 3/06; C08K 3/36; C08K 5/01; C08K 5/101; C08K 5/31; C08K 5/47; C08K 5/548; C08L 7/00; C08K 2201/006; C08L 2205/025; C08L 2205/03

(57) ABSTRACT

The present invention relates to a tread of a tyre having a tread pattern with a longtotal index (As) equal to or less than 17; said tread being characterized in that it is made up of a rubber composition comprising: (a) a crosslinkable unsaturated chain polymer base comprising from 10 to 50 phr of a modified styrene-butadiene copolymer rubber having a glass-transition temperature (Tg), measured by differential scanning calorimetry, of −50° C. or less; (b) a filler comprising 40 to 100 phr of silica; (c) a plasticizer system comprising a hydrocarbon resin and from 8 to 25 phr of octyloleate; and (d) a vulcanization system; said hydrocarbon resin having a softening point of 110° C. or higher, and an average molecular weight comprised between 700 and 1500 g/mol.

### BACKGROUND

The present invention relates to a tread of a tire, and to a winter tire comprising such tread. In particular, the present invention finds advantageous, but not exclusive, application in passenger car tires (PSR TIRE), to which the following description will make explicit reference without thereby losing generality.

Winter tires must meet the safety requirements relating to their grip performance in winter conditions, i.e. in conditions of ice and snow.

In order to guarantee even safer vehicles operations in winter weather conditions, winter tires should also guarantee a high performance in terms of wet braking. Such a requirement is difficult to achieve since, generally, the solutions that promote wet braking, at the same time, lead to a worsening of the terms of road grip in winter conditions.

The combination of property of a tread of a tire can be achieved by tailoring the tread pattern design characteristic as well as the rubber composition of which the tread pattern is made. Both technologies may act in synergy to meet the expected requirements.

Usually, rubber compositions for use in tread for winter tires need to remain soft in low temperature conditions. Softer tires are able to engage more efficiently with the icy or snowy road surface, improving grip and handling. Unlike summer tires, harden which quickly in cold temperatures, winter tires perform best in temperatures below +7 degrees C.

Conventionally, rubber compositions used for treads for winter tires contain natural rubber (NR) and polybutadiene rubber (BR) as a major synthetic component of the rubber blend. NR ensure softness of the composition and BR is known to provide the necessary level of grip required in temperature condition below +7 degrees C., because of its intrinsically low glass transition temperature (Tg).

Instead, an increase in the amount of silica and/or solution stirene-butadiene (sSBR) in the tread rubber composition, while leading to a significant increase in terms of wet braking, at the same time lead to a worsening in terms of grip on snow and ice.

Tread pattern characteristics that lead to optimal winter performance are, for example, the depth of the tread grooves, which provide a cavity for snow thereby providing enhanced grip, or the number, the geometry and the arrangement of the sipes in the tread blocks.

Herein and after the term “rib” refers to the raised section of the tread pattern, spaced by the grooves and made up of tread blocks.

Herein and after, the term “groove” refers to the channels which run along the longitudinal direction and axial direction of the tire, which provide a space between two adjacent tread ribs, or two adjacent tread blocks, having a width higher than 2 mm and a depth along the radial direction of the tire at least higher than 50% of the full tread depth.

Herein and after, the term “tread depth” refers to the distance from the surface of the tread to the bottom of the deepest groove.

Herein and after, the term “longitudinal direction” refers to the rolling direction of the tire and is conventionally identified in a cartesian plane as the direction along the y axis.

Herein and after, the term “axial direction” refers to the direction perpendicular to the longitudinal direction, extending laterally with respect to the tire rolling direction and is conventionally identified in a cartesian plane as the direction along the x axis.

Herein and after, the term “radial direction” refers to the direction along the radius of the tire, that is to say any direction that passes through the axis of rotation of the tire and is substantially perpendicular to this direction, and is conventionally identified in a cartesian plane as the direction along the z axis.

Herein and after the term “tread blocks” refers to the raised rubber segments, delimited by edges, that make contact with the road surface and provide traction.

Herein and after, the term “sipe” refers to any of the small and narrow incisions molded in the tread blocks having the shape of periodically repeated elements drawn up across the axial and/or longitudinal direction of the tire, having at least two end points and aa width of at most 1 mm, suitable for providing extra traction and preventing skids.

Herein and after, the term “sipe element” refers to any of the periodically repeated straight lines of which the sipe is constituted.

Herein and after, the term “slot” refers to any narrow incision molded in the tread blocks of a tire, having at least two end points and having a width at least higher than 1 mm and up to 2 mm and a depth at least lower than 50% of the full tread depth.

Herein and after, the term “block edge” refers to the portion of the tread block adjacent to a a slot or a grove.

It is known that the sipes of a winter tread pattern are able to enhance tire traction and stopping distance. In normal conditions, sipes make the tire tread more flexible and increase the ability of the tire to push into small variations on road surfaces, favoring road contact and a stronger grip. In wet conditions, sipes are responsible to break the water film to avoid hydroplaning by channeling water outside the contact area between tire and road surface, increasing the wet grip. In winter conditions, sipes increase traction as the incisions open as the tread is pushed against the road and capture snow inside. Normally, the sipe's and block edges' geometry and configuration is aimed to balance pattern stiffness, in order to achieve high performances both in terms of winter and wet traction.

Accordingly there is a need to find a solution for a winter tread combining composition and pattern properties, which is able to achieve high wet traction performance while maintaining good winter performance on snow and ice.

### SUMMARY

The inventors of the present invention have devised a solution able of satisfying the aforementioned need, resulting in a significant improvement both in terms of wet braking and in terms of grip on snow and ice. In particular, the present invention combination of a particular tread pattern with a particular composition by which the tread itself is made up.

A first aspect of the present invention is a tread of a tire having a tread pattern with a longtotal index (As) equal to or less than 17; said tread being characterized in that it is made up of a rubber composition comprising (a) a crosslinkable unsaturated chain polymer base comprising from 10 to 50 phr of a modified stirene-butadiene copolymer rubber having a glass-transition temperature (To) of −50° C. or less; (b) a filler comprising 40 to 100 phr of silica; (c) a plasticizer system comprising an hydrocarbon resin and from 8 to 25 phr of octyloleate; and (d) a vulcanization system said hydrocarbon resin having a softening point comprised between 11° and 145° C., preferably between 11° and 128° C. and an average molecular weight comprised between 700 and 1500 g/mol.

A second aspect of the present invention is a winter tire comprising a tread according to the first aspect.

### BRIEF DESCRIPTION OF THE SEVERAL VIEWS OF THE DRAWINGS

FIG. 1 is an example of a detail of the front view of a tread (1), comprising tread blocks (4) with respective block edges (5) being adjacent to grooves (2) or slots (3), the tread blocks comprising sipes (6), wherein each sipe is formed of several sipe elements (7).

### DETAILED DESCRIPTION

Herein and after, the term “cross-linkable unsaturated-chain polymer base” refers to any natural or synthetic non-cross-linked polymer capable of assuming all of the chemical-physical and mechanical characteristics typically assumed by elastomers after cross-linking (vulcanization) with sulfur-based systems.

Here and hereinafter, vulcanization system refers to a complex of ingredients comprising curing agent, e.g. sulfur, and accelerating compounds, that in the preparation of the composition are added in a final mixing stage and have the purpose of promoting the vulcanization of the polymer base once the composition is subjected to a vulcanization temperature.

Herein and after the term “longtotal index (As)” refers to the sum of the projections of the sipes (6) and the block edges (5), taking into account every single element (7) of which the sipe (6) or block edge (5) is drawn up, along the tire axial direction, divided by the circumference of the tire, and is calculated by the following formula:

$${A}_{s} = \frac{{{\sum }^{♯ sipes}}_{i} {L}_{s , i} ( cos {θ}_{s , i} ) \hat{} 2}{TireCirc}$$

Ls (cos Os) is the orthogonal projection of each single element (7) constituting the sipe (6) or block edge (5), along the axial direction of the tire.

The higher is the value of the longtotal index As, the higher is the number of the sipes (6) and of the block edges (5) which are overall oriented in the axial direction; the lower is the value of the longtotal index, the lower is the number of the sipes (6) and of the block edges (5) which are overall oriented in the axial direction.

Preferably, said tread pattern has a longtotal index As equal to or less than 15.

More preferably, said tread pattern has a longtotal index As equal or less than 13.

The rubber composition according to the present invention contains from 10 to 50 phr of a modified stirene-butadiene copolymer rubber having a glass-transition temperature (Tg) of −50° C. or less. A preferred example of the said modified stirene-butadiene copolymer rubber is described in EP3372639A1 (paragraphs-[0065]) which is herein included by reference. Preferably said modified stirene-butadiene copolymer is included in the rubber composition in a quantity ranging from 20 to 40 phr, more preferably 20 to 30 phr.

The rubber composition according to the present invention contains a hydrocarbon resin. In certain embodiments, the softening point of the hydrocarbon resin is 110° C. or higher, preferably 115° C. or higher, preferably 118° C. or higher. From the perspective of suppressing an increase in tanδ at 0° C., the softening point of the hydrocarbon resin is preferably 145° C. or lower. For example, the softening point may be 143° C. or lower, 140° C. or lower, 136° C. or lower, 135° C. or lower, 133° C. or lower, or 130° C. or lower. From the perspective of miscibility of the resin with the rubber component, the weight average molecular weight of the hydrocarbon resin will generally be in the range from 700 to 1500 g/mol. The weight average molecular weight is determined by gel permeation chromatography (GPC) relative to polystirene standards.

In some embodiments, the weight average molecular weight of the resin may be 800 g/mol or higher, preferably 900 g/mol or higher, more preferably 1000 g/mol or higher. In other embodiments, the weight average molecular weight of the hydrocarbon resin may be 1400 g/mol or lower, preferably 1300 g/mol or lower, more preferably 1200 mol/g or lower.

In one embodiment, the hydrocarbon resin will have a softening point higher than 100° C. and a weight average molecular weight of 700 to 1500 g/mol. More preferably, the hydrocarbon resin will be a fully hydrogenated C9 resin having a softening point higher than 100° C. and a weight average molecular weight of 700 to 1500 g/mol.

The hydrocarbon resin is one produced by subjecting a resin to substantially complete (e.g. complete) reductive hydrogenation. The resin used as the starting material is selected from C5 resins, C5/C9 resins, C9 resins and combinations thereof.

Examples of the C5 resin which may be used to produce a fully hydrogenated C5 resin include aliphatic petroleum resins obtained by (co)-polymerizing a C5 fraction obtained by pyrolysis of naphtha in the petrochemical industry. The C5 fraction normally contains olefin-based hydrocarbons, such as 1-pentene, 2-pentene, 2-methyl-1-butene, 2-methyl-2-butene, and 3-methyl-1-butene; di-olefin-based hydrocarbons, such as 2-methyl-1,3-butadiene, 1,2-pentadiene, 1,3-pentadiene, and 3-methyl-1,2-butadiene. It may also contain other monomers, for example DCPD. Any commercially available product may be employed as the C5 resin.

The term “C5/C9 resin” refers to a C5-C9 synthetic petroleum resin, and examples include a petroleum derived C5-C11 fraction including AlC13; solid polymers obtained by polymerization using a Friedel-Crafts catalyst such as BF3, and more specific examples thereof include copolymers containing stirene, vinyl toluene, «-methyl stirene, indene, or the like as main components. From the perspective of compatibility with the rubber component, a resin having a small amount of C9 or greater components is preferable as the C5/C9 resin. For example, the amount of C9 or greater components may be less than 50 wt. %, and preferably less than 40 wt. %, based on the total amount of the resin. Any commercially available product can be used as the C5/C9 resin.

The term “C9 resin” refers to a C9 synthetic petroleum resin and examples include a polymer obtained by polymerization using a Friedel-Crafts catalyst such as AlC13 or BF3. Examples of the C9 resin include a copolymer containing indene, stirene, α-methyl stirene, vinyl toluene, or the like as main components. Any commercially available product may be employed as the C9 resin. Examples include resins having a softening point of about 118-128° C., a weight average molecular weight (Mw) of about 1100 g/mol, and a glass transition temperature (Tg) of about 65-75° C.

The glass transition temperature (Tg) of the hydrocarbon resin stirene-butadiene and the modified copolymer is measured by differential scanning calorimetry (DSC). Tg values reported herein are determined using DSC, starting temperature: −140° C.; temperature ramp: 15° C./min. Unless otherwise specified, all test methods herein described are conducted at 23° C. and 50% relative humidity.

As used herein, the term “fully hydrogenated” means that the resin component contains less than 5% olefinic protons. In some embodiments, the fully hydrogenated resin may contain less than 4% olefinic protons, preferably less than 3%, more preferably less than 2%, e.g. less than 1%, less than 0.5%, or less than 0.1%, e.g. less than 0.05%. In one embodiment, the fully hydrogenated resin may contain from 0 to about 3% olefinic protons, i.e. it will be about 97 to 100% hydrogenated. In one embodiment, the fully hydrogenated resin may contain from 0 to about 2% olefinic protons, i.e. it will be about 98 to 100% hydrogenated. In one embodiment, the fully hydrogenated resin may contain from 0 to about 1% olefinic protons, i.e. it will be about 99 to 100% hydrogenated. In one embodiment, it may contain about 0% olefinic protons. In a preferred embodiment the hydrocarbon resin is included in the rubber composition in a quantity ranging from 2 to 15 phr, more preferably from 5 to 10 phr.

The rubber composition object of the present invention comprises silica as a filler. Any known silica filler or combination of different types of silica can be used in the rubber compositions herein described. The silica may be selected according to its specific surface area. The average specific surface area of the silica may be determined by N2 adsorption herein referred as NSA, nitrogen surface area, measured according to the Brunauer-Emmett-Teller (BET) method; and by cetyltrimethylammonium bromide (CTAB) adsorption. The CTAB specific surface area is the external surface. The Brunauer-Emmet-Teller (BET) method is described in the Journal of the American Chemical Society, Vol. 60, page 309, February 1938, and corresponding to standard NF ISO 5794-1, Appendix D (June 2010). The cetyltrimethylammonium bromide (CTAB) adsorption method corresponds to ASTM D6845. The silica for use in the invention may have a NSA in the range of from 105 and 145 m²/g. The silica for use in the invention may have a CTAB specific surface area of from 100 and 130 m²/g. The silica may be comprised in the rubber composition according to the invention in a quantity ranging from 40 to 100 phr, preferably from 50 to 90 phr, more preferably from 60 to 80 phr.

In a preferred embodiment the rubber composition further comprise a silane coupling agent. Silane coupling agent are used to increase the compatibility of silica with the cross-linkable polymer base. Any silane coupling agent known to the subject matter expert may be used in the rubber composition. In a preferred embodiment the silane coupling agent used in the rubber composition is bis(triethoxysilylpropyl) disulfide (Si 75). The silane coupling agent may be introduced in the rubber composition in a quantity ranging from 3 to 10 phr.

In a preferred embodiment silica is not the only filler included in the rubber composition, which further comprises carbon black. Carbon black may be introduced in the composition in a quantity ranging from 3 to 20 phr, more preferably 5 to 15 phr, more preferably 8 to 12 phr.

The rubber composition object of the present invention further comprises octyl oleate in the plasticizer system. According to present invention, octyl oleate is introduced in the composition in a quantity ranging from 8 to 25 phr, more preferably from 10 to 20 phr.

In a preferred embodiment the cross-linkable polymer base comprises natural rubber (NR) and polybutadiene rubber (BR). NR is included in the rubber composition in a quantity ranging from 40 to 60 phr, preferably from 45 to 55 phr, and BR is included in the rubber composition in a quantity ranging from 15 to 50 phr, more preferably from 20 to 30 phr.

Preferably, said cross-linkable unsaturated-chain polymer base comprises from 20 to 30 phr of a modified stirene-butadiene copolymer rubber having a glass-transition temperature (Tg) of −50° C. or less, from 45 to 55 phr of NR and from 20 to 30 phr of BR.

In a preferred embodiment, the tread object of the present invention is used for passenger tires.

A second aspect of the present invention is a winter tire comprising a tread according to the first aspect.

### EXAMPLES

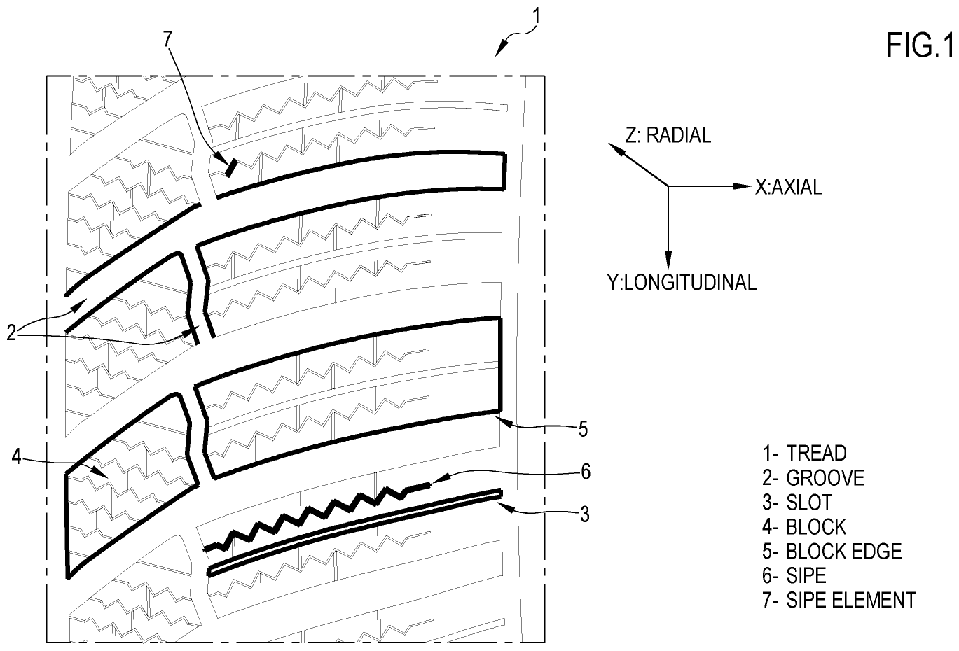

The following examples are for illustrative and non-limiting purposes for a better understanding of the invention with the help of FIG. 1, which illustrates three different tread patterns.

Four compositions (A-D) were made up. A first composition (A) is a reference composition, while the other three compositions (B-D) are compositions according to the invention. Each of the four compositions was subsequently subjected to a series of tests in order to evaluate their adhesion in wet conditions and in winter conditions. In particular, the values of TanD at 0° C. and E′ at −20° C. were measured for each of the compositions, which are respectively indicative of wet braking and grip index in winter conditions.

The compositions of the examples are obtained according to the procedure below:

### —Preparation of the Compositions—

### (1st Mixing Phase)

In a tangential rotors mixer having an internal volume between 230 and 270 liters, all the ingredients except the vulcanization system were loaded before the start of mixing, reaching a filling factor of between 66-72%.

The mixer was operated at a speed between 40 and 60 rpm, and the mixture formed was discharged once it reached a temperature between 14° and 160° C.

### (2nd Mixing Phase)

The mixture obtained from the previous phase was again mixed in a mixer at a speed between 40 and 60 rpm and, subsequently, discharged once a temperature between 13° and 150° C. was reached.

### (3rd Mixing Phase)

The vulcanization system was added to the mixture obtained from the previous phase, reaching a filling factor between 63 and 67%.

The mixer was operated at a speed between 20 and 40 rpm, and the mixture formed was discharged once it reached a temperature between 100-110°c.

Table I shows the four rubber compositions A-D.

TABLE I

| | | A | B | C | D |
|---|---|---|---|---|---|
| Polymer | NR | 50 | 50 | 50 | 50 |
| | BR | 50 | 25 | 25 | 25 |
| | Modified SBR | — | 25 | 25 | 25 |
| Filler | Silica | 52 | 70 | 63 | 70 |
| | CB (N234) | 16.6 | 10 | — | 10 |
| | CB (N330) | — | — | 10 | — |
| Silane binding | Si75 | 4.16 | 5.6 | 5.2 | 5.6 |
| agent | | | | | |
| Plasticizer | Octyloleate | 6 | 14 | 14 | 17 |
| | MES oil | 15 | 10 | — | 5 |
| | Hydrocarbon | — | 7 | 7 | 11 |
| | resin | | | | |
| | Aromatic C9 | 7 | — | — | — |
| | resin | | | | |
| Vulcanization | Sulphur | 1.35 | 1.35 | 1.35 | 1.35 |
| system | TBBS | 0.85 | 1.15 | 1.15 | 1.15 |
| | DPG | 0.7 | 1 | 1 | 1 |
| | MBTS | 0.65 | 0.9 | 0.9 | 0.9 |

NR is a 1,4-cis polyisoprene rubber of natural origin.
BR is a polymer base consisting of polybutadiene.

Modified SBR was prepared by the following procedure: A cyclohexane solution of 1,3-butadiene and a cyclohexane solution of stirene were charged in a dry, nitrogen-purged pressure-resistant glass vessel (800 mL), such that 1,3-butadiene monomer was 67.5 g and stirene was 7.5 g; 0.6 mmol of 2,2-di(tetrahydrofuryl) propane and 0.8 mmol of n-butyllithium were added thereto; then polymerization was performed at 50° C. for 1.5 hours. With respect to the polymerization reaction system of which the polymerization conversion rate was approximately 100% at this time, 0.72 mmol of the modifier was added, and modification reaction was performed at 50° C. for 30 minutes. Afterward, 2 mL of 5 mass % 2,6-di-t-butyl-p-cresol (BHT) in isopropanol was added to terminate the reaction, and the modified SBR was obtained by drying with an ordinary method. As a result of measuring the microstructure of the obtained modified SBR, the bound stirene content was 10 mass %, the vinyl content of the butadiene moiety was 40%, and the peak molecular weight was 200,000.

The silica used is marketed by Evonik under commercial name ULTRASIL5500 GR

CB is carbon black classified as N234 or N330.

The silane binding agent used is Si75, marketed by Evonik

Octyloleate is marketed by Traquisa under commercial name Permavis T

MES oil is marketed by Nynas under commercial name Nytex832

The hydrocarbon resin used is a fully hydrogenated C9 resin

Aromatic C9 resin is marketed by Rain Carbon Inc. under the commercial name Novares TD100

As is evident from Table I, the compositions of the present invention differ from the comparison composition in (i) the use of modified SBR among the polymeric bases, (ii) a higher quantity of silica and octyloleate and (iii) the use of an hydrocarbon resin in the plasticizer system.

As mentioned above, for the A-D compositions the values of TanD at 0° C. and E′ at −20° C. were measured (according to ASTM D5992 standard).

Table II shows the results of the tests carried out.

TABLE II

| | A | B | C | D |
|---|---|---|---|---|
| TanD at 0° C. * | 100 | 106 | 107 | 107 |
| E′ at −20° C. ** | 100 | 95 | 93 | 97 |

* higher is better
** lower is better

The four compositions A-D were tested on three different tread patterns (Pattern 1-3).

Patterns 1-3 are represented in FIG. 1. In particular, Patterns 1 and 2 are out of the invention and have a longtotal index equal to 22.2 and 19.8 respectively, and the Pattern 3 is an example of the invention and has a longtotal index equal to 11.5.

Each of the three Patterns was made up alternately with each of the four rubber compositions of table I.

The twelve treads made up by the combination of the three Patterns and the four rubber compositions were tested in terms of wet braking. The wet braking performance was determined by the braking distance of 80 km/h on wet roads. In particular, meters of braking from 80 kph to 20 kph are measured.

Table III shows the values of the wet braking test. In order to more clearly display the advantages of the compositions according to the invention, the values of Table III were indexed to the combination pattern 1 and composition A. The higher the value the better the wet braking.

TABLE III

| | Compound A | Compound B | Compound C | Compound D |
|---|---|---|---|---|
| Pattern 1 | 100 | 102 | 101 | 104 |
| Pattern 2 | 97 | 103 | 100 | 103 |
| Pattern 3 | 88 | 106 | 106 | 108 |

Furthermore, the six treads obtained by making Patterns 1-3 with compositions A and C have been tested in terms of snow traction. The snow traction performance was determined by timing (seconds are measured) to accelerate from 5 km/h to 35 km/h on road covered by snow.

Snow traction: seconds taken to pass from 5 kph to 35 kph.

Table IV shows the values of the snow traction. In order to more clearly display the advantages of the compositions according to the invention, the values of Table IV were indexed to the combination pattern 1 and composition A. The higher the value the better the snow traction.

TABLE IV

| | Compound A | Compound C |
|---|---|---|
| Pattern 1 | 100 | 100 |
| Pattern 2 | 105 | 104 |
| Pattern 3 | 107 | 106 |

As can be seen from the values shown in Tables III and IV, the treads obtained according to the dictates of the present invention, i.e. by combining Pattern 3 with the B D compositions, guarantee both improved performance in terms of wet braking and, at the same time, highest levels by snow traction.

To sum up, the inventors of the present invention have the merit of having found that a tread with a tread pattern with longtotal index (As) less than or equal to 17 if made up with a rubber blend having a particular composition in terms of polymeric base, amount of silica and plasticizer system, can satisfy the safety requirements in terms of wet grip of winter treads.

1-13. (canceled)

14. A tire tread comprising:
a tread pattern with a longtotal index equal to or less than 17;
a rubber composition comprising:
a crosslinkable unsaturated chain polymer base comprising from 10 to 50 phr of a modified stirene-butadiene copolymer rubber having a glass-transition temperature of −50° C. or less;
a filler comprising 40 to 100 phr of silica;
a plasticizer system comprising a hydrocarbon resin and from 8 to 25 phr of octyloleate; and
a vulcanization system;
wherein the hydrocarbon resin comprises a softening point of 110° C. or higher, and an average molecular weight comprised between 700 and 1500 g/mol.

15. The tire tread of claim 14, wherein the glass-transition temperature is measured by differential scanning calorimetry.

16. The tire tread of claim 14, wherein the tread pattern has a longtotal index equal to or less than 15.

17. The tire tread of claim 16, wherein the tread pattern has a longtotal index less than 13.

18. The tire tread of claim 14, wherein the crosslinkable unsaturated chain polymer base further comprises from 15 to 50 phr of polybutadiene rubber (BR) and from 40 to 60 phr of natural rubber (NR).

19. The tire tread of claim 14, wherein the plasticizer system comprises from 2 to 15 phr of hydrocarbon resin having a softening point comprised between 118 and 128° C. and an average molecular weight comprised between 700 and 1500 g/mol.

20. The tire tread of claim 14, wherein the silica has a surface area having a cetyltrimethylammonium bromide (CTAB) value comprised between 100 and 130 m²/g and a nitrogen surface area (NSA) value comprised between 105 and 145 m²/g.

21. The tire tread of claim 20, wherein the CTAB value is measured according to ASMT D6845 and the NSA value is measured by Brunauer-Emmett-Teller (BET) method.

22. The tire tread of claim 14, wherein the hydrocarbon resin has a glass-transition temperature comprised between 65 and 75° C.

23. The tire tread of claim 22, wherein the glass-transition temperature is measured by differential scanning calorimetry.

23. The tire tread of claim 14, wherein the hydrocarbon resin contains less than 5% of olefinic protons.

24. The tire tread of claim 14, wherein the cross-linkable unsaturated-chain polymer base comprises from 20 to 40 phr of a modified stirene-butadiene copolymer rubber having a glass-transition temperature of −50° C. or less, from 45 to 55 phr of natural rubber, and from 20 to 30 phr of polybutadiene rubber.

25. The tire tread of claim 24, wherein the cross-linkable unsaturated-chain polymer base comprises from 20 to 30 phr of the modified stirene-butadiene copolymer rubber.

26. The tire tread of claim 14, wherein the filler comprises carbon black and from 60 to 80 phr of silica.

27. The tire tread of claim 14, wherein the plasticizer system comprises from 5 to 10 phr of hydrocarbon resin and from 10 to 20 phr of octyloleate.

28. The tire tread of claim 14, wherein the rubber composition further comprises a silane coupling agent.

29. The tire tread of claim 28, wherein the rubber composition comprises Si75.

30. A passenger tire comprising the tire tread of claim 14.

31. A winter tire comprising the tire tread of claim 14.
